(19) United States
(12) Patent Application Publication
(10) Pub. No.: US 2007/0060194 A1
(43) Pub. Date: Mar. 15, 2007

(54) MOBILE COMMUNICATION APPARATUS

(76) Inventor: Lin Chung Sheng, Taoyuan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/531,417

(22) Filed: Sep. 13, 2006

(30) Foreign Application Priority Data
Sep. 14, 2005 (TW) 094131579

(51) Int. Cl. H04M 1/00

(52) U.S. Cl. 455/550.1

(57) ABSTRACT

A mobile communication apparatus includes a housing having a recess formed on a top surface thereof, N sets of resilient pins disposed in the recess, and a keypad. The keypad is rotatably mounted in the recess, and N guiding grooves are formed on a bottom surface of the keypad. Each of the guiding grooves corresponds to one of the N sets of resilient pins. The keypad has N sets of first contact points where each set is disposed in the corresponding guiding groove, and N sets of second contact points where each set is disposed in the corresponding guiding groove. When the keypad is positioned at a first position, each set of resilient pins contacts the corresponding set of first contact points, and when the keypad rotates from the first position to a second position, each set of resilient pins contacts the corresponding set of second contact points.

### BACKGROUND OF THE INVENTION

1. Field of the Invention

The invention relates to a mobile communication apparatus, and more particularly to a mobile communication apparatus with a rotatable keypad.

2. Description of the Prior Art

Recently, as science and technology develop and improve, mobile communication apparatus, such as mobile phone, personal digital assistant (PDA) and so on, has more and more functions. To enable a user to easily operate each function, various mechanisms have been developed. For example, conventional mobile communication apparatus always have various built-in games for the purpose of entertainment. When the user uses a mobile communication apparatus to play games, he/she often needs to rotate the keypad with a specific angle (e.g. 90°) to facilitate the operation. A conventional mobile communication apparatus with a rotatable keypad has been disclosed in Japan patent No. JP2003134214.

In the aforementioned Japan patent, circuit connection of the rotatable keypad is achieved via wiring. In this way, during the rotation of the keypad, if the user accidentally touches any function key, the corresponding function will be executed at the same time. It's an annoying problem for the user. Furthermore, since circuit connection is achieved via wiring, bad contact may occur when the mobile communication apparatus has been used for a span of time. Moreover, electric wires occupy more space and the cost is high.

Therefore, the scope of the invention is to provide a mobile communication apparatus with a rotatable keypad to solve the aforementioned problems.

### SUMMARY OF THE INVENTION

The scope of the invention is to provide a mobile communication apparatus utilizing two sets of resilient pins and corresponding contact points to transmit data. When the keypad rotates with a specific angle, the mobile communication apparatus cannot be used until each set of resilient pins contacts the corresponding set of contact points, so as to ensure the mobile communication apparatus a long life-span and reduce cost.

The invention discloses a mobile communication apparatus with a rotatable keypad. The mobile communication apparatus includes a housing, N sets of resilient pins and a keypad. The housing has a top surface and a recess formed on the top surface. The N sets of resilient pins are disposed in the recess and exposed outside the housing. The keypad is rotatably mounted in the recess. The keypad has a bottom surface corresponding to the top surface of the housing. N guiding grooves are formed on the bottom surface of the keypad, and each of the guiding grooves corresponds to one of the N sets of resilient pins and covers the corresponding set of resilient pins. The keypad also includes N sets of first and second contact points. Each set of first contact points corresponds to one of the guiding grooves and is disposed in the corresponding guiding groove. Each set of second contact points corresponds to one of the guiding groove and is disposed in the corresponding guiding groove.

When the keypad is positioned at a first position relative to the housing, each set of resilient pins will contact the corresponding set of first contact points disposed in the guiding groove. When the keypad rotates from the first position to a second position relative to the housing, each set of resilient pins will contact the corresponding set of second contact points disposed in the guiding groove.

According to the mobile communication apparatus of the invention, circuit connection is achieved by having the resilient pins making contact with the corresponding contact points, such that the mobile communication apparatus is temporarily broken off while the keypad rotates. Therefore, life-span of the mobile communication apparatus can be ensured in an acceptable range. Furthermore, cost for products using current invention is lower than the prior art.

The advantage and spirit of the invention may be understood by the following recitations together with the appended drawings.

### BRIEF DESCRIPTION OF THE APPENDED DRAWINGS

FIG. 1 is an outside view illustrating a mobile communication apparatus according to a preferred embodiment of the invention.

FIG. 2 is an outside view illustrating a keypad rotating relative to the mobile communication apparatus shown in FIG. 1.

FIG. 3 is an exploded view illustrating partial mobile communication apparatus shown in FIG. 1.

FIG. 4 is a back view illustrating a PCB shown in FIG. 3.

FIG. 5A is a partial view illustrating each set of resilient pins contacting the corresponding first contact points when the keypad shown in FIG. 1 is positioned at the first position.

FIG. 5B is a partial view illustrating each set of resilient pins contacting the corresponding second contact points when the keypad shown in FIG. 2 is positioned at the second position.

FIG. 6 is an outside view illustrating the housing shown in FIG. 3.

FIG. 7 is a back view illustrating the rotatable plate shown in FIG. 3.

FIG. 8A is a partial view illustrating each of three bosses is retained by the corresponding first indentation when the keypad shown in FIG. 1 is positioned at the first position.

FIG. 8B is a partial view illustrating each of three bosses is retained by the corresponding second indentation when the keypad shown in FIG. 2 is positioned at the second position.

### DETAILED DESCRIPTION OF THE INVENTION

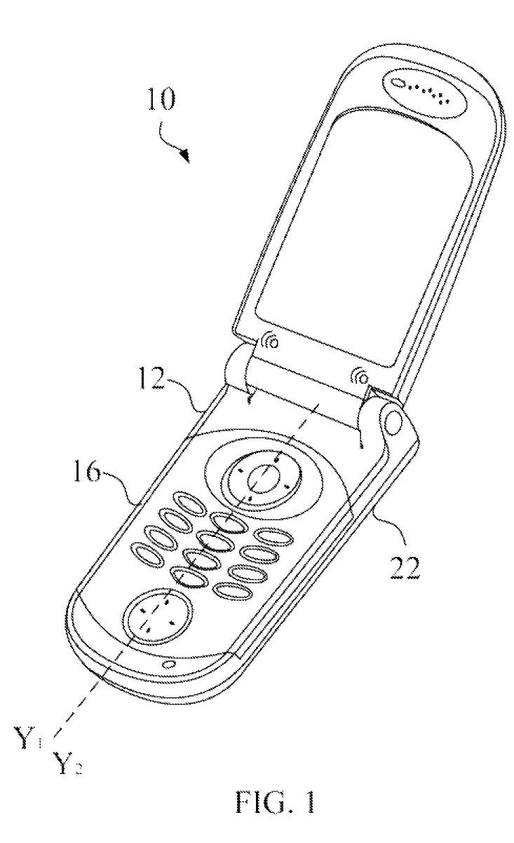

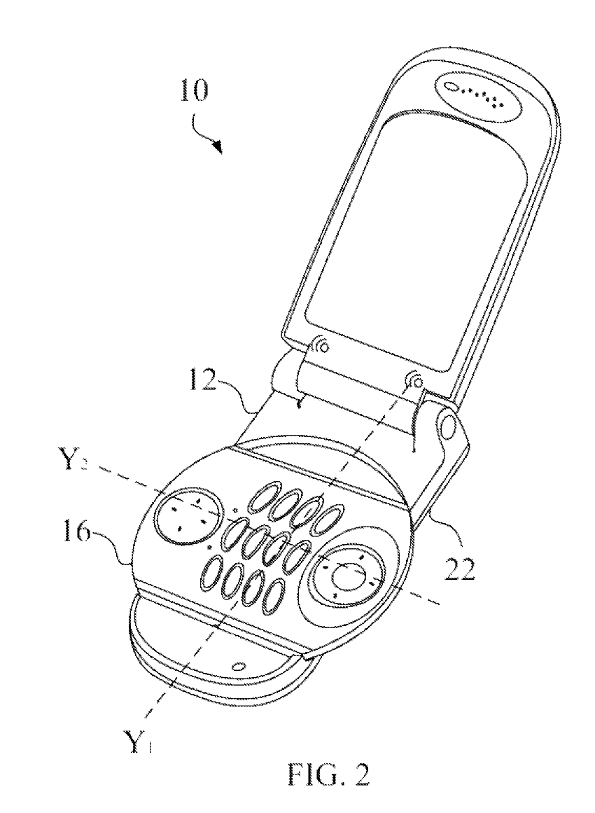

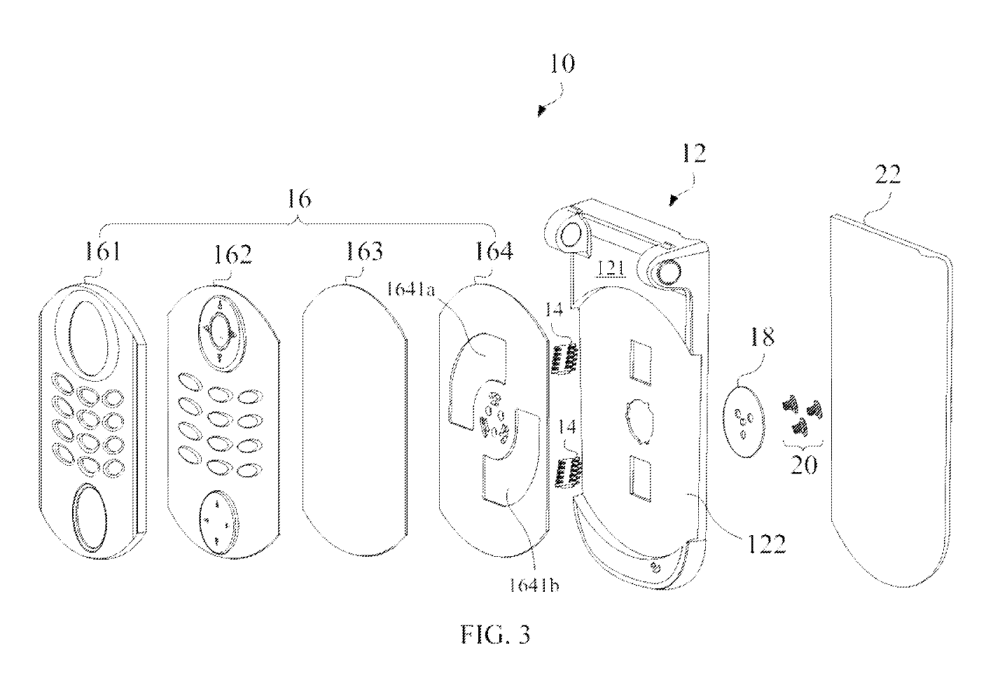

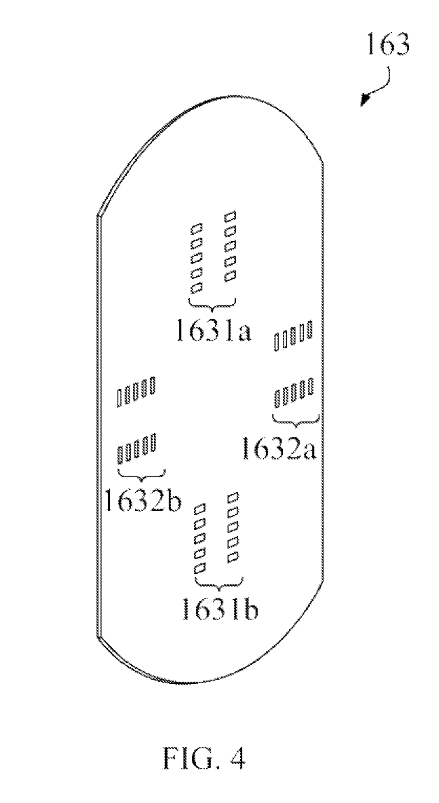

Referring to FIGS. 1 through 4, FIG. 1 is an outside view illustrating a mobile communication apparatus 10 according to a preferred embodiment of the invention. FIG. 2 is an outside view illustrating a keypad 16 rotating relative to the mobile communication apparatus 10 shown in FIG. 1. FIG. 3 is an exploded view illustrating partial mobile communication apparatus 10 shown in FIG. 1. FIG. 4 is a back view illustrating a printed circuit board (PCB) 163 shown in FIG. 3. The mobile communication apparatus 10 includes a housing 12, N sets of resilient pins 14, a keypad 16 and a back cover 22. In this embodiment, the mobile communication apparatus 10 includes two sets of resilient pins 14, and the keypad 16 further includes a keypad shell 161, a keypad plate 162, a printed circuit board 163 and a rotatable plate 164, as shown in FIG. 3.

The housing 12 has a top surface 121 and a recess 122 formed on the top surface 121, and a first axis Y₁ is defined on the top surface 121. The two sets of resilient pins 14 are respectively disposed in the recess 122 and exposed outside the housing 12. The keypad 16 is rotatably mounted in the recess 122. The rotatable plate 164 of the keypad 16 provides a bottom surface corresponding to the top surface 121 of the housing 12, and a second axis Y₂ is defined on the bottom surface. Two guiding grooves 1641a and 1641b are formed on the rotatable plate 164 of the keypad 16. Each of the guiding grooves 1641a and 1641b corresponds to one of the two sets of resilient pins 14 and covers the corresponding set of resilient pins 14. The PCB 163 of the keypad 16 also includes two sets of first contact points 1631a and 1631b and two sets of second contact points 1632a and 1632b, as shown in FIG. 4. The set of first contact points 1631a and the set of second contact points 1632a both correspond to the guiding groove 1641a and are disposed in the corresponding guiding groove 1641a. The set of first contact points 1631b and the set of second contact points 1632b both correspond to the guiding groove 1641b and are disposed in the corresponding guiding groove 1641b.

In this embodiment, when the keypad 16 is positioned at a first position relative to the housing 12, an angle between the first axis Y₁ and the second axis Y₂ is equal to 0°, as shown in FIG. 1. When the keypad 16 is positioned at a second position relative to the housing 12, the angle between the first axis Y₁ and the second axis Y₂ is equal to 90°, as shown in FIG. 2. It should be noted that the angle between the first axis Y₁ and the second axis Y₂ can be designed based on practical application.

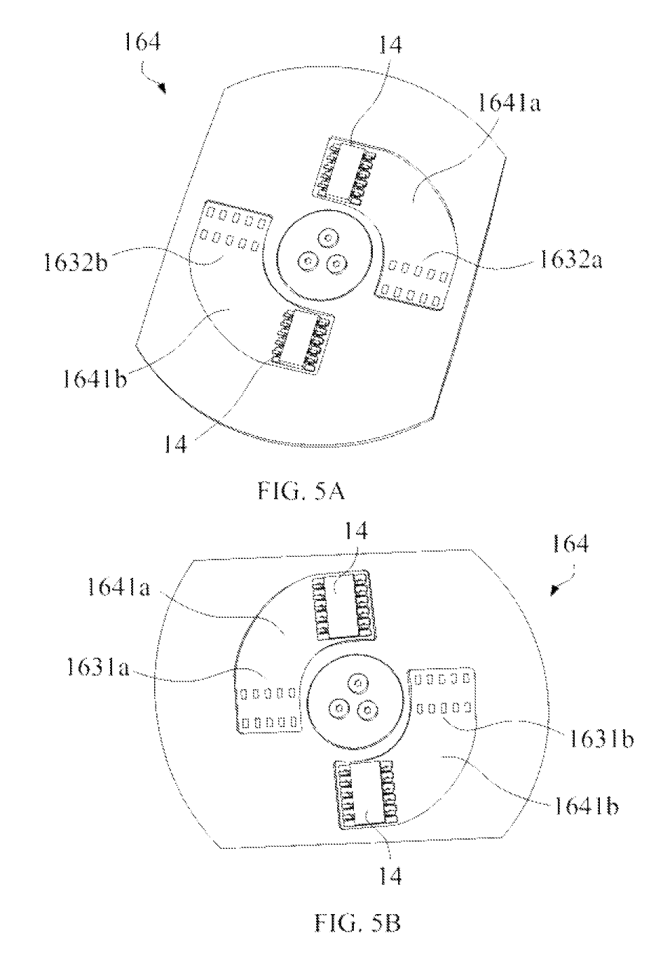

Referring to FIGS. 5A and 5B, FIG. 5A is a partial view illustrating each set of resilient pins contacting the corresponding first contact points when the keypad 16 shown in FIG. 1 is positioned at the first position. FIG. 5B is a partial view illustrating each set of resilient pins contacting the corresponding second contact points when the keypad 16 shown in FIG. 2 is positioned at the second position. When the keypad 16 is positioned at the first position relative to the housing 12, each set of resilient pins 14 will contact the corresponding set of first contact points 1631a and 1631b disposed in the guiding grooves 1641a and 1641b, as shown in FIG. 5A. When the keypad 16 rotates from the first position to the second position relative to the housing 12, each set of resilient pins 14 will contact the corresponding set of second contact points 1632a and 1632b disposed in the guiding grooves 1641a and 1641b. Accordingly, only when each set of resilient pins contacts the corresponding set of contact points, circuit of the mobile communication apparatus 10 is then switched on. In other words, the mobile communication apparatus 10 is temporarily broken off while the keypad rotates.

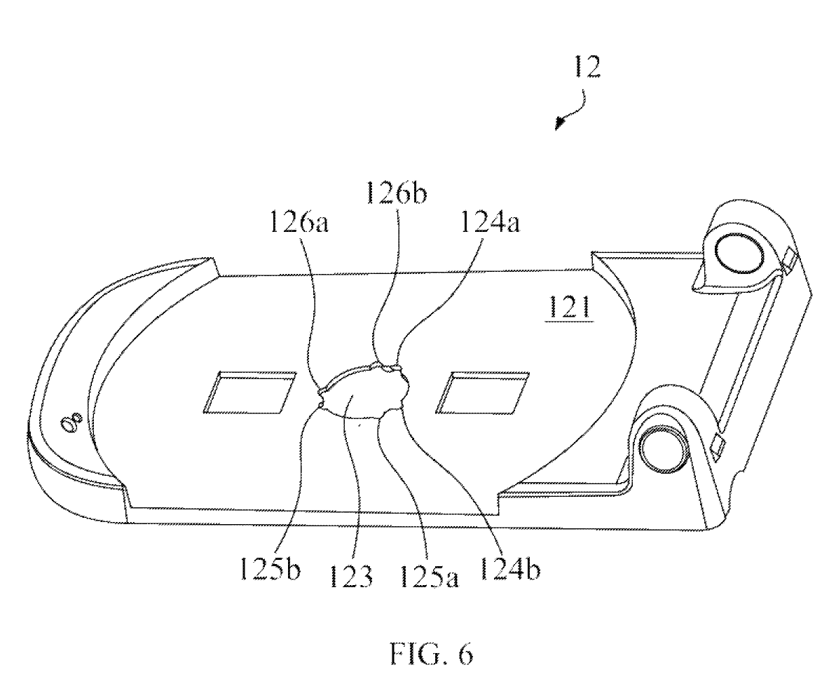

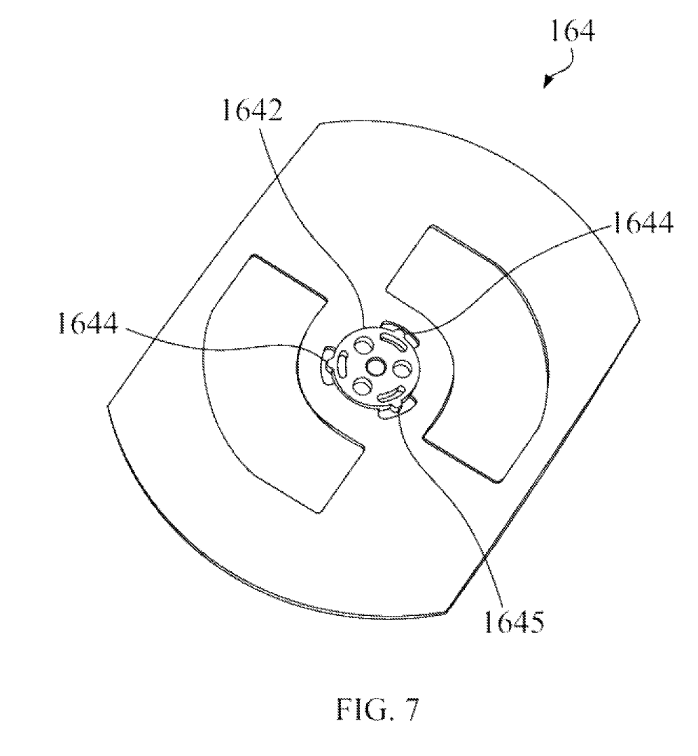

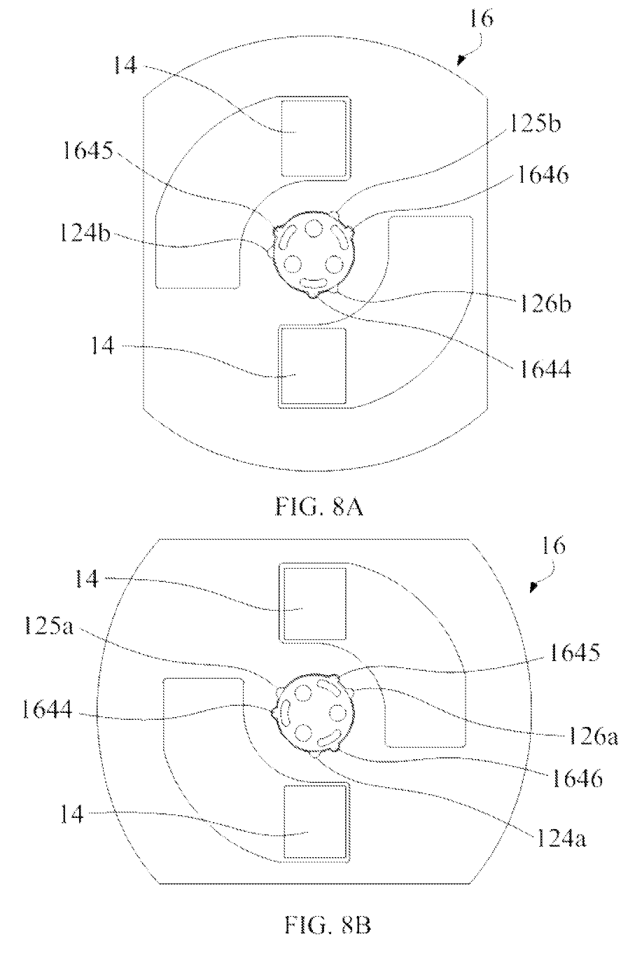

Referring to FIGS. 6 through 8B, FIG. 6 is an outside view illustrating the housing 12 shown in FIG. 3. FIG. 7 is a back view illustrating the rotatable plate 164 shown in FIG. 3. FIG. 8A is a partial view illustrating each of three bosses is retained by the corresponding first indentation when the keypad 16 shown in FIG. 1 is positioned at the first position. FIG. 8B is a partial view illustrating each of three bosses is retained by the corresponding second indentation when the keypad 16 shown in FIG. 2 is positioned at the second position.

The housing 12 also has an orientation hole 123, M first indentations and M second indentations. In this embodiment, the housing 12 has three first indentations 124a, 125a and 126a and three second indentations 124b, 125b and 126b, as shown in FIG. 6. The orientation hole 123 is formed through and on the top surface 121. The first and second indentations are formed at circumference of the orientation hole 123, and each of the second indentations corresponds to one of the first indentations, respectively. For example, the second indentation 124b corresponds to the first indentation 124a. As shown in FIG. 7, the rotatable plate 164 of the keypad 16 has a central shaft 1642 mating the orientation hole 123. The central shaft 1642 thereon has three bosses 1644, 1645 and 1646 each corresponding to one of the three first indentations and one of the three second indentations, respectively. For example, the boss 1644 corresponds to the first indentation 124a and the second indentation 124b. In this embodiment, when the keypad 16 is positioned at the first position, each of the bosses is retained by the corresponding first indentation, as shown in FIG. 8A. When the keypad 16 rotates from the first position to the second position, each of the bosses is retained by the corresponding second indentation, as shown in FIG. 8B. For practical application, rotation angle of the keypad can be changed based on arrangement of the bosses and the corresponding indentations.

Referring to FIG. 3 again, the mobile communication apparatus 10 of the invention also includes an engaging plate 18 and T screws 20. In this embodiment, the mobile communication apparatus 10 includes three screws 20. The engaging plate 18 corresponds to the central shaft 1642 of the rotatable plate 164 and is disposed in the housing 12. The engaging plate 18 has three first engaging holes each having an inner thread. The central shaft 1642 also has three second engaging holes each having an inner thread. Each of the second engaging holes corresponds to one of the first engaging holes. The keypad 16 is rotatably mounted in the recess 122 of the housing 12 by bolting each of the screws through the corresponding first engaging hole in the corresponding second engaging hole.

In another preferred embodiment of the invention, the mobile communication apparatus 10 may further include three copper pillars (not shown). Each of the copper pillars corresponds to one of the second engaging holes and is disposed in the corresponding second engaging hole, so as to provide an inner thread of the corresponding second engaging hole.

Compared to the prior art, circuit connection of the invention is achieved by having the resilient pins making contact with the corresponding contact points, such that the mobile communication apparatus is temporarily broken off while the keypad rotates. Therefore, life-span of the mobile communication apparatus can be ensured in an acceptable range. Furthermore, cost for products using current invention is lower than the prior art.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A mobile communication apparatus comprising:
a housing having a top surface and a recess formed on the top surface;
N sets of resilient pins disposed in the recess and exposed outside the housing; and
a keypad rotatably mounted in the recess, the keypad having a bottom surface corresponding to the top surface of the housing, N guiding grooves being formed on the bottom surface, each of the guiding grooves corresponding to one of the N sets of resilient pins and covering the corresponding set of resilient pins, the keypad comprising N sets of first contact points where each set of first contact points corresponds to one of the guiding grooves and is disposed in the corresponding guiding groove, and N sets of second contact points where each set of second contact points corresponds to one of the guiding groove and is disposed in the corresponding guiding groove;
wherein when the keypad is positioned at a first position relative to the housing, each set of resilient pins contacts the set of first contact points disposed in the guiding groove corresponding to said one set of resilient pins; and
wherein when the keypad rotates from the first position to a second position relative to the housing, each set of resilient pins contacts the set of second contact points disposed in the guiding groove corresponding to said one set of resilient pins.

2. The mobile communication apparatus of claim 1, wherein a first axis is defined on the top surface of the housing, a second axis is defined on the bottom surface of the keypad, when the keypad is positioned at the first position relative to the housing, an angle between the first axis and the second axis is equal to 0°, and when the keypad is positioned at the second position relative to the housing, the angle between the first axis and the second axis is equal to 90°.

3. The mobile communication apparatus of claim 1, wherein the housing has an orientation hole formed through and on the top surface, M first indentations and M second indentations each corresponding to one of the M first indentations, the M first and second indentations are formed at a circumference of the orientation hole, the keypad has a central shaft formed on the bottom surface and mating the orientation hole, and the central shaft thereon has M bosses each corresponding to one of the M first indentations and one of the M second indentations; when the keypad is positioned at the first position relative to the housing, each of the M bosses is retained by the corresponding first indentation, and when the keypad rotates from the first position to the second position relative to the housing, each of the M bosses is retained by the corresponding second indentation.

4. The mobile communication apparatus of claim 3, further comprising:
an engaging plate corresponding to the central shaft and disposed in the housing, the engaging plate having T first engaging holes; and
T screws;
wherein the central shaft also has T second engaging holes each corresponding to one of the T first engaging holes, the keypad is rotatably mounted in the recess by bolting each of the T screws through the corresponding first engaging hole in the corresponding second engaging hole.

5. The mobile communication apparatus of claim 4, wherein each of the T first engaging holes has an inner thread.

6. The mobile communication apparatus of claim 5, wherein each of the T second engaging holes has an inner thread.

7. The mobile communication apparatus of claim 5, further comprising T copper pillars each corresponding to one of the second engaging holes and disposed in the corresponding second engaging hole to provide an inner thread of the corresponding second engaging hole.
